(19) United States
(12) Patent Application Publication
(10) Pub. No.: US 2025/0026110 A1
(43) Pub. Date: Jan. 23, 2025

(54) A PACKAGING MATERIAL COMPRISING A POLYMER COATING

(71) Applicant: Stora Enso OYJ, Helsinki (FI)

(72) Inventors: Kimmo Nevalainen, Kotka (FI); Inkeri Perttu-Ukonaho, Lappeenranta (FI); Esa Suikkanen, Imatra (FI); Minna Vuorimaa, Kotka (FI); Timo Lankinen, Imatra (FI); Anna Veijalainen, Imatra (FI)

(73) Assignee: Stora Enso OYJ, Helsinki (FI)

(21) Appl. No.: 18/713,880

(22) PCT Filed: Nov. 28, 2022
(86) PCT No.: PCT/IB2022/061478

§ 371 Date: May 28, 2024

(30) Foreign Application Priority Data
Nov. 29, 2021 (SE) 2130334-2

(51) Int. Cl. B32B 21/08; B29C 48/00; B29C 48/153; B29C 48/21; B29K 23/00; B29L 31/00; B32B 37/15

(52) U.S. Cl. CPC B32B 21/08; B29C 48/022; B29C 48/153; B29C 48/21; B32B 37/153; B29K 2023/0633; B29L 2031/7132; B32B 2255/12; B32B 2307/718; B32B 2323/046

(57) ABSTRACT

The present invention relates to a packaging material comprising a paperboard substrate comprising a first and a second side, an extrusion coated polymer layer attached to the first side, which polymer layer comprises polyethylene (PE) with a melt index in the range of 7-10 g/10 min, as measured using ASTM D1238, wherein the polymer layer has a grammage of less than 12 gsm, preferably less than 10 gsm. The invention further relates to a method of producing such a packaging material and a cup being made from or comprising said packaging material.

### FIELD OF THE INVENTION

The present invention relates to a packaging material, a cup being made from the packaging material and a method to produce such a packaging material.

### BACKGROUND

Paper or paperboard as such is generally suitable for the packaging of dry products. However, untreated paperboard is of limited use in direct contact with moist or greasy products, because moisture will affect the mechanical properties of the packaging and absorbed grease will cause staining of the paper. These effects will impair the protective function as well as the appearance of the packaging. Polyethylene (PE) coating of paper and paperboard is often suitable for packaging applications where moisture barrier properties are important. Examples include packages for fresh and frozen foods, such as vegetables, meats, fish, and ice cream. One important application for PE coated paperboard is for the manufacture of waterproof paper cups.

Extrusion coating is a process by which a molten plastic material is applied to a substrate, such as paper or paperboard to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

Extrusion coating may be used to achieve, e.g., moisture protection, barrier properties for water vapour, oxygen, aromas, etc., dirt or grease resistance, heat sealability, and/or to impart a desired finish or texture to a substrate surface.

Extrusion coating drastically expands the range of applications for paper and paperboard. The thin plastic layer imparts resistance to grease and moisture and also in some instances heat resistance. The plastic coatings can also be used for heat sealing. Depending on the application, the paper or paperboard may be extrusion coated on one or both sides.

For environmental and economic reasons, it is generally desirable to keep the plastic coating as thin as possible, as long as the barrier and protective properties are maintained at an acceptable level. In many cases however, further reduction of the thickness (or grammage) of the plastic coating is limited by impaired adhesion and stability of the film formation in the extrusion process, and the formation of pinholes. For example, PE is typically extrusion coated to a grammage of 15-25 grams per square meter. PE resins conventionally used in the manufacture of paper cups cannot be extrusion coated on paper or paperboard to a grammage of less than 12 grams per square meter, without loss of adhesion, reduced heat sealability and increased pinhole formation, leading to imperfections in the coated product.

Pinholes are microscopic holes that can form in the plastic film during the coating process. The main reasons for the appearance of pinholes include irregularities in the substrate surface (e.g. high surface roughness or loose fibres), an uneven coating distribution, or too low coating grammage.

Adhesion can be improved by surface treatment of the substrate for example with corona discharge or ozone, but there remains a need for improved solutions for reducing plastic coating grammage in extrusion coating of PE, while maintaining good adhesion, low pinhole formation and stability of the film formation in the extrusion process.

### DESCRIPTION OF THE INVENTION

It is an object of the present disclosure to reduce the minimum grammage of a polyethylene coating required to achieve sufficient adhesion, low pinhole formation, and/or stability of the film formation in extrusion coating.

It is a further object of the present disclosure to provide a packaging material comprising a polyethylene layer, which allows for reduced total grammage of polyethylene coating, while maintaining good adhesion of the polyethylene coating layer to the paperboard and avoiding the formation of pinholes.

It is a further object of the present disclosure to provide a method for manufacturing polyethylene coated paper or paperboard, which allows for reduced grammage of the polyethylene layer, while maintaining good stability of the film formation in the extrusion process.

The above-mentioned objects, as well as other objects as will be realized by the skilled person in the light of the present disclosure, are achieved by the various aspects of the present disclosure.

In a first aspect, the invention discloses a packaging material comprising:
a paperboard substrate comprising a first and a second side,
an extrusion coated polymer layer attached to the first side, which polymer layer comprises polyethylene (PE) with a melt index in the range of 7-10 g/10 min, as measured using ASTM D1238,
   wherein the polymer layer has a grammage of less than 12 gsm, preferably less than 10 gsm.

“Paperboard substrate” as used herein refers to a fiber based substrate comprising cellulose fibers. A typical paperboard substrate used for packaging material comprises at least one ply, preferably several plies. The paperboard substrate may comprise bleached and/or unbleached fibers and it may be surface sized. The paperboard substrate is preferably a multilayer packaging paperboard, comprising at least two plies, a back ply and a top ply. The paperboard substrate may comprise for example a top and a back ply and at least one middle ply. The paperboard substrate may have a basis weight of at least 120 gsm, or at least 150 gsm, preferably at least 180 gsm.

The term “extrusion coated polymer layer” refers to a polymer layer applied using extrusion coating techniques.

Melt index as expressed herein is measured in accordance with ASTM D1238 and may also be referred to as the melt flow rate.

The grammage, sometimes referred to as basis weight, of a paperboard substrate or a coating- or polymer layer refers to the weight expressed as grams per square meter, gsm or g/m². As used herein, gsm and g/m² may be used interchangeable.

The inventors to the present invention have surprisingly found that using a polyethylene with a melt index in the range of 7-10 g/10 min enables the application of a polymer layer with a grammage of less than 12 gsm, or even less than 10 gsm, while problems with poor adhesion and pin-hole formation still can be reduced or avoided. The inventors have found that if the melt index of the polyethylene is too low, edge weave may occur when applying such thin layers, which may cause pinholes in the formed polymer film. If, on the other hand, the melt index of the polyethylene is too high, this may affect the adhesion of the polymer layer to the paperboard substrate negatively.

In some embodiment, the packaging materials does not comprise any further synthetic polymer layers. The polymer layer is preferably the only barrier layer applied on the paperboard substrate. In this embodiment, the polymer layer may be applied directly onto and adjacent the first side of the paperboard and form an outermost layer of the packaging material.

The polymer layer applied on the packaging material of the invention comprises few or no pinholes. In embodiments, the polymer layer comprises less than 10 pinholes per m as measured using EN 13676:2001.

The packaging material is further easily repulpable. The reject received from the repulping of the packaging material (determined according to PTS test method RF1021/97) is preferably less than 10 wt %, preferably less than 7 wt % or less than 5 wt %, based on a dry weight of the packaging material of 100 wt %

In some embodiments, the polymer layer consists essentially of a low density polyethylene (LDPE). Low density polyethylene (LDPE) has rheological properties that are suitable for production of film by extrusion. LDPE has some long branches and many short branches. The melt strength and the shear-thinning nature of LDPE enhance processing. LDPE films have relatively low tensile strength but good impact strength. LDPE films show good clarity and gloss. LDPE is obtained by the high-pressure radical polymerization process, typically in an autoclave or tubular reactor. The autoclave generally results in more branching and broader molecular weight distribution. LDPE has a broad melting range, with a peak melting temperature of 110° C. The density of LDPE is typically in the range of from 0.910 to 0.940 g/cm3.

In some embodiments, the polymer layer essentially consists of bio-based polyethylene. The inventors have surprisingly found that the use of bio-based polyethylene enables even thinner polymer coating grammages to be applied without compromising with pinhole formation or adhesion.

As used herein, the wording “bio-based polyethylene” means that the monomers of the polyethylene are derived from renewable resources, such as sugar, cane, corn, rice, potatoes, wheat and vegetable oil.

As used herein, the wording “consists essentially of” means that the polymer layer consists of at least 95 wt %, preferably at least 98 wt %, of the component in question. The remaining portion may be other polymers or additives.

The polymer layer is preferably free from inorganic fillers.

In embodiments, the polymer layer comprises at least a first and a second sub-layer. Such sub-layers can be formed by co-extrusion. Alternatively, the sub-layers could be formed from a single extruder, but divided into two layers by a feed block from which the materials are transferred to the die which spread the melted material. Preferably, the second sub-layer has a grammage in a range of ≥1 to ≤2 gsm, while the first sub-layer may have a grammage in a range of >2 to ≤10 gsm. It has been shown that the application of an extra thin layer, in combination with one or more slightly thicker layer reduces the pin-hole formation even further.

The polymer layer may, in a preferred embodiment, comprise a first, a second and a third sub-layer, wherein the first sub-layer is attached directly onto the first side of the paperboard substrate, said second sub-layer is attached to the first sub-layer and the third sub-layer is attached to the second sub-layer.

The packaging material may further comprise a pigment coating on the second side of the paperboard substrate. The pigment coating may comprise pigments and biners. Pigments are commonly made of calcium carbonate (such Precipitated Calcium Carbonate (PCC) or Ground Calcium Carbonate (GCC)), clay (such as kaolin or calcined kaolin), TiO2, talcum, plastic pigments, Al2O3, ATH, SiO2, or nanopigments such as bentonite, or mixtures thereof. Binders are added to increase the adhesion of the particles of pigment to each other and to the paper fibers. Binders are commonly made from common natural sources such as starch, protein, or from synthetic sources, such as styrene-butadiene and vinyl acrylic latices.

In a second aspect, the invention defines a cup being made from or comprising a packaging material according to the first aspect, wherein the polymer layer forms the inner side of the cup and is adapted to be in contact with the content of the cup. Preferably, the pigment coating forms the outer side of the cup and provides a surface for printing. The cup of the invention is particularly suitable for hot drinks and frozen food for instant use, e.g. ice cream.

In a third aspect, the invention defines a method for manufacturing a packaging material comprising:
a) providing a paperboard substrate comprising a first and a second side,
b) applying a layer of a molten polymeric resin to the first side by extrusion coating to form a first polymer layer with a grammage of less than 12 gsm, said polymeric resin essentially consisting of a polyethylene with a melt index in the range of 7-10 g/10 min, as measured using ASTM D1238,
c) allowing the polymer layer to cool down and solidify.

In embodiments, the layer of polymeric resin comprises at least a first and a second sub-layer, which are formed simultaneously by co-extrusion.

The method of the third aspect may be further characterized by the features defining the packaging material according to the first aspect of the invention.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A packaging material comprising:
a paperboard substrate comprising a first side and a second side,
an extrusion coated polymer layer attached to the first side,
wherein the extrusion coated polymer layer comprises polyethylene (PE) with a melt index in a range of 7-10 g/10 min, as measured using ASTM D1238,
wherein the extrusion coated polymer layer has a grammage of less than 12 gsm.

2. The packaging material according to claim 1, wherein the packaging material does not comprise any further synthetic polymer layers.

3. The packaging material according to claim 1, wherein the extrusion coated polymer layer is applied directly onto and adjacent the first side of the paperboard substrate and wherein the extrusion coated polymer layer forms an outermost layer of the packaging material.

4. A The packaging material according to claim 1, wherein the extrusion coated polymer layer comprises less than 10 pinholes per m², as measured using EN 13676:2001.

5. The packaging material according to claim 1, wherein a reject received from a re-pulping of the packaging material, determined according to PTS test method RH021/97, is less than 10 weight % based on a dry weight of the packaging material of 100 weight %.

6. The packaging material according to claim 1, wherein the extrusion coated polymer layer has a grammage of less than 10 gsm.

7. The packaging material according to claim 1, wherein the extrusion coated polymer layer consists essentially of a low density polyethylene (LDPE).

8. The packaging material according to claim 1, wherein the extrusion coated polymer layer essentially consists of bio-based polyethylene.

9. The packaging material according to claim 1, wherein the extrusion coated polymer layer comprises at least a first sub-layer and a second sub-layer.

10. The packaging material according to claim 9, wherein the at least first and second sub-layers are formed by co-extrusion onto the first side of the paperboard substrate.

11. A The packaging material according to claim 9, wherein the polymer layer comprises a first, a second, and a third sub-layer, and
wherein the first sub-layer is attached directly onto the first side of the paperboard substrate, said second sub-layer is attached to the first sub-layer, and the third sub-layer is attached to the second sub-layer.

12. The packaging material according to claim 11, wherein the second sub-layer has a grammage of between 1-2 gsm.

13. The packaging material according to claim 1, further comprising:
a pigment coating applied on the second side of the paperboard substrate.

14. A cup made from or comprising:
the packaging material according to claim 1, wherein the extrusion coated polymer layer forms an inner side of the cup and is configured to be in contact with contents of the cup.

15. A method for manufacturing a packaging material, comprising:
a) providing a paperboard substrate comprising a first side and a second side,
b) applying a layer of a molten polymeric resin to the first side by extrusion coating to form a first polymer layer with a grammage of less than 12 gsm, said molten polymeric resin essentially consisting of a polyethylene with a melt index in a range of 7-10 g/10 min, as measured using ASTM D1238, and,
c) allowing the first polymer layer to cool down and solidify.

16. The method according to claim 15, wherein the first polymer layer of polymeric resin comprises at least a first sub-layer and a second sub-layer, wherein the first and second sub-layers are formed simultaneously by co-extrusion.
